(19) United States
(12) Patent Application Publication
(10) Pub. No.: US 2020/0281207 A1
(43) Pub. Date: Sep. 10, 2020

(54) METHOD OF USING MACROCYCLIC ACTIVATED PEROXIDES FOR MICROBE REDUCTION

(71) Applicant: PHILLIPS 66 COMPANY, HOUSTON, TX (US)

(72) Inventors: Vrajesh Mehta, Richmond, TX (US); Arren Washington, Bartlesville, OK (US)

(73) Assignee: PHILLIPS 66 COMPANY, HOUSTON, TX (US)

(21) Appl. No.: 16/806,671

(22) Filed: Mar. 2, 2020

Related U.S. Application Data
(60) Provisional application No. 62/813,435, filed on Mar. 4, 2019.

(51) Int. Cl. A01N 55/02; A01N 59/06; A01N 59/00; C02F 1/50; C02F 1/72

(52) U.S. Cl. CPC A01N 55/02; A01N 59/06; A01N 59/00; C02F 2303/20; C02F 1/722; C02F 2303/04; C02F 1/50

(57) ABSTRACT

A method treating an aqueous environment containing at least one microbe, with a mixture comprising a macrocyclic ligand and a peroxide. The treatment reduces the number of microbes in the aqueous environment.

### CROSS-REFERENCE TO RELATED APPLICATIONS

This application is a non-provisional application which claims the benefit of and priority to U.S. Provisional Application Ser. No. 62/813,435 filed Mar. 4, 2019, titled “Method of Using Macrocyclic Activated Peroxides for Microbe Reduction,” which is hereby incorporated by reference in its entirety.

### STATEMENT REGARDING FEDERALLY SPONSORED RESEARCH OR DEVELOPMENT

None.

### FIELD OF THE INVENTION

This invention relates to use of macrocyclic activated peroxides for microorganism destruction.

### BACKGROUND OF THE INVENTION

Microbial infection and the formation of biofilm present significant complications in numerous industries. Although biofilm are known to exist in a wide-variety of environmental conditions, since biofilm most often form on surfaces exposed to bacteria and water, industries such as food processing are commonly affected by biofilm. Biofilms are biological conglomerates that contain pathogens, such as bacteria and other microorganisms, embedded in a matrix of exopolymers and macromolecules. In addition to bacteria, other microorganisms are commonly found in biofilm, including fungi, molds, algae, protozoa, archaea and mixtures of these microorganisms. Biofilms form as a result of microorganisms establishing on a surface and producing a protective extracellular polymeric matrix. Most often biofilm form on surfaces in contact with water, providing a hydrated matrix of polysaccharides to provide structural protection from biocides, making biofilm more difficult to kill than other pathogens.

Biofilm growth and removal depends on several factors, including the surface composition and chemical composition of the surrounding environment. Several biofilm removal methods are utilized, including physical, chemical and biological removal.

Failure to develop a satisfactory solution to biofilms could result in continued slowing of the growth of the relevant industry, increase in the cost of water management and adverse effects on health and environment.

The methods and systems described in this document are directed to treatment of wastewater containing biocides such as those generated from cooling towers of refineries.

### BRIEF SUMMARY OF THE DISCLOSURE

A method of treating an aqueous environment containing at least one microbe, with a mixture comprising a macrocyclic ligand and a peroxide. The treatment reduces the number of microbes in the aqueous environment.

A method of batch reacting, in an aqueous environment containing at least one biofilm with, a mixture comprising a tetra-amido macrocyclic ligand and a hydrogen peroxide. In this method the amount of the tetra-amido macrocyclic ligand is greater than 1 ppm of the aqueous environment. Additionally, in this method the amount of the hydrogen peroxide is greater than 300 ppm of the aqueous environment. It is envisioned that this method would occurs at a temperature ranging from about 15° C. to about 35° C. Additionally, this method would reduce the number of biofilms in the aqueous environment.

A method of continuous flow reacting, in an aqueous environment containing at least one biofilm with, a mixture comprising a tetra-amido macrocyclic ligand and a hydrogen peroxide. In this method the amount of the tetra-amido macrocyclic ligand is greater than 1 ppm of the aqueous environment. Additionally, in this method the amount of the hydrogen peroxide is greater than 300 ppm of the aqueous environment. It is envisioned that this method would occurs at a temperature ranging from about 15° C. to about 35° C. Additionally, this method would reduce the number of biofilms in the aqueous environment.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts the treatments following the macrocyclic ligand.

FIG. 2 depicts the treatments following hypochlorite solution.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present method discloses a method of treating an aqueous environment containing at least one microbe. This aqueous environment is treated with a mixture comprising a macrocyclic ligand and a peroxide. The result of this treatment reduces the number of microbes in the aqueous environment.

In one embodiment the treatment is specifically targeted towards a biofilm, which is a biologically derived environment produced by multiple microbes. In other embodiments, the method will treat microbes and microbe components such as: polysaccharides, lipids, proteins, and nucleic acids. These biofilms and other extracellular biomaterial may also be found in other locations such as tank bottoms, overhead liquid transfer piping, and wastewater treatment.

It is envisioned that this process will reduce the number of microbes and/or biofilm by at least 25%. In other embodiments, the process can eliminate the number of microbes and/or biofilm in the aqueous environment. In yet other embodiments, the number of microbes and/or biofilm reduces can be 35%, 45%, 55%, 65%, 75%, 85%, even 95%.

In one embodiment, the aqueous environment can be from refinery cooling towers and the related components such as walls and pipes. It is theorized that the microbes could be free flowing throughout the aqueous environment, or they can be attached to surfaces found in cooling towers, walls, and pipes. The temperature of the aqueous environment can range from about 15° C. to about 35° C. Other components in the aqueous environment, can be carbon and other nutrients such as nitrogen and phosphorus.

In one embodiment the peroxide used is hydrogen peroxide. In another embodiment, the peroxide is a metal peroxide or an organic peroxide. In other embodiments, the peroxide used is a combination of different peroxides. Different types of metal peroxides that can be used individually or in combination include: calcium peroxide, sodium peroxide, magnesium peroxide, barium peroxide, lithium peroxide, tert-butyl hydroperoxide. The amount of peroxide for this treatment can be greater than 100 ppm of the aqueous environment to be treated. In other embodiments, the amount of peroxide can be greater than 200 ppm, 300 ppm, 400 ppm, 500 ppm, 600 ppm, 700 ppm, 800 ppm, 900 ppm or even 10000 ppm of the aqueous environment to be treated.

Broadly, macrocyclic ligands can be defined as cyclic molecules consisting of organic frames which heteroatoms have been interspersed. For the applicability of this method macrocyclic ligands can include both synthetic macrocyclic ligands and naturally occurring species of macrocyclic ligands. In one embodiment, macrocyclic ligands can be described as rings with at least nine members and three or more donor atoms. These macrocyclic ligands can be mixed donor macrocyclic ligands, polyaza macrocyclic ligands, polythia macrocyclic ligands, polyoxa macrocyclic ligands, or even oxa macrocylic ligands.

In another embodiment the macrocyclic ligand used is tetra-amido macrocyclic ligand. In other embodiments, the macrocyclic ligand used is a combination of different macrocyclic ligands. Different types of macrocyclic ligands that can be use individually or in combination include: tetra-amido macrocyclic ligand, cyclam macrocyclic ligand, a crown ether macrocyclic ligand, and a porphyrin macrocyclic ligand. The amount of macrocyclic ligands for this treatment can range from 0.05 to 50 ppm of the aqueous environment to be treated. In other embodiments, the amount of macrocyclic ligands for this treatment can be greater than 0.1 ppm, 1 ppm, 2 ppm, 5 ppm, 10 ppm, 25 ppm, 50 ppm, 75 ppm, 100 ppm, or even 150 ppm of the aqueous environment to be treated.

The treatment can be done in both a batch reaction or part of a continuous flow reaction.

In one method the macrocyclic ligand can be added to the aqueous environment followed by the peroxide. In another embodiment, the peroxide can be added to the aqueous environment followed by the macrocyclic ligand. In yet another embodiment, both the macrocyclic ligand and the peroxide can be simultaneously added to the aqueous environment. In yet another embodiment, the mixing of the macrocyclic ligand and the peroxide can occur prior to incorporation into the aqueous environment. In this embodiment, the mixture of the macrocyclic ligand and the peroxide can occur via any known method known by one skilled in the art.

In one embodiment, it is envisioned that the incorporation of the hydrogen peroxide and macrocyclic ligand is done in such a way to promote effervescence and create a locally turbulent environment.

The following examples of certain embodiments of the invention are given. Each example is provided by way of explanation of the invention, one of many embodiments of the invention, and the following examples should not be read to limit, or define, the scope of the invention.

### Example 1

Throughout this experiment, the presence of biomaterial (both biofilm and cells) was tracked qualitatively by measuring the absorbance of light at various wavelengths. The more biomaterial present, the higher the absorbance value.

Pseudomonas fluorescens was selected as a model biofilm forming bacteria. A live culture was grown first in a culture flask by inoculating growth media from a frozen stock. The flask was placed in a shaker-top incubator at 30° C. shaking at 75 rpm. Following this, live cultures were transferred to multi-well tissue culture plates. Each well received 1 mL of growth culture and 1 mL of fresh media.

After 2 weeks, a biofilm was clearly visible. Wells were gently washed with three aliquots of 2 mL DI water. Following this, biocide/biodispersant was added.

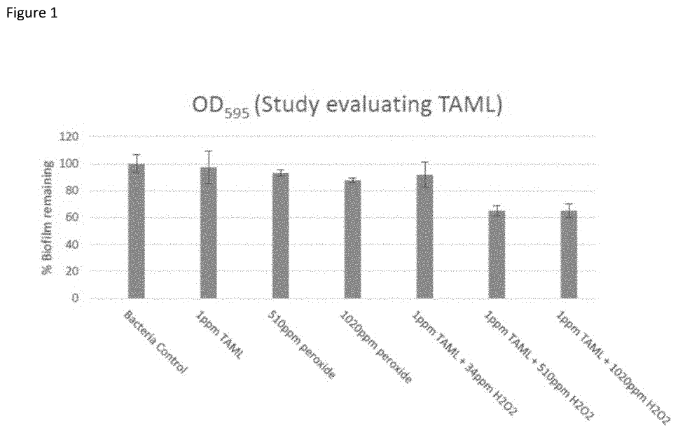

FIG. 1 depicts the treatments following the macrocyclic ligand.

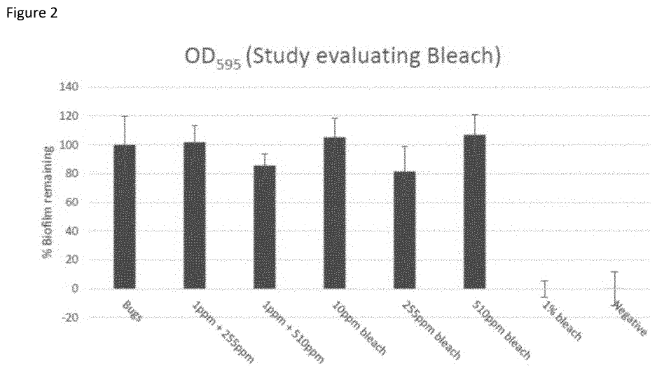

FIG. 2 depicts the treatments following hypochlorite solution.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method comprising:
treating an aqueous environment containing at least one microbe, with a mixture comprising a macrocyclic ligand and a peroxide,
wherein the treatment reduces the number of microbes in the aqueous environment.

2. The method of claim 1, wherein the at least one microbe contains at least one biofilm.

3. The method of claim 1, wherein the macrocyclic ligand is selected from the group consisting of: a tetra-amido macrocyclic ligand, a cyclam macrocyclic ligand, a crown ether macrocyclic ligand, a porphyrin macrocyclic ligand, and combinations thereof.

4. The method of claim 1, wherein the peroxide is a metal peroxide.

5. The method of claim 1, wherein the peroxide is selected from the group consisting of: hydrogen peroxide, calcium peroxide, sodium peroxide, magnesium peroxide, barium peroxide, lithium peroxide, tert-butyl hydroperoxide, and combinations thereof.

6. The method of claim 1, wherein the treatment reduces the number of microbes by at least 25%.

7. The method of claim 1, wherein the amount of macrocyclic ligand is greater than 1 ppm of the aqueous environment.

8. The method of claim 1, wherein the treatment is done in a batch reaction.

9. The method of claim 1, wherein the treatment is done in a continuous flow reaction.

10. A method comprising:
batch reacting, in an aqueous environment containing at least one biofilm with, a mixture comprising a tetra-amido macrocyclic ligand and a hydrogen peroxide,
wherein the amount of the tetra-amido macrocyclic ligand is greater than 1 ppm of the aqueous environment, wherein the amount of the hydrogen peroxide is greater than 300 ppm of the aqueous environment,
wherein the batch reaction occurs at a temperature ranging from about 15° C. to about 35° C.,
and wherein the mixture reduces the number of biofilms in the aqueous environment.

11. A method comprising:
injecting, into a continuous flow aqueous environment containing at least one biofilm with, a mixture comprising a tetra-amido macrocyclic ligand and a hydrogen peroxide,
wherein the amount of the tetra-amido macrocyclic ligand is greater than 1 ppm of the aqueous environment,
wherein the amount of the hydrogen peroxide is greater than 300 ppm 1 ppm of the aqueous environment,
and wherein the mixture reduces the number of biofilms in the aqueous environment.
